(19) United States
(12) Patent Application Publication
(10) Pub. No.: US 2004/0254973 A1
(43) Pub. Date: Dec. 16, 2004

(54) Rounding mode insensitive method and apparatus for integer rounding

(76) Inventors: Ping T. Tang, Hayward, CA (US); John R. Harrison, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/461,849

(22) Filed: Jun. 13, 2003

(51) Int. Cl. G06F 7/38

(52) U.S. Cl. 708/670

(57) ABSTRACT

A method and apparatus for integer rounding are described herein. In one embodiment, exemplary method includes adding a first value with a first constant, resulting in a second value, optionally performing a rounding operation on the second value, resulting in a third value, and extracting at least a portion of bits from the third value to generate an integer component corresponding to the first value, the first constant being selected such that an accuracy of the integer component is independent of a rounding mode of the rounding operation. Other methods and apparatuses are also described.

### FIELD

Embodiments of the invention relate to the field of processing computations; and more specifically, to rounding mode insensitive integer rounding.

### BACKGROUND

In many processing systems today, such as personal computers (PCs), mathematical computations play an important role. Numerical algorithms for computation of many mathematical functions, such as exponential and trigonometric operations, require the decomposition of floating-point numbers into their associated integer and fractional parts. These operations may be used for argument reduction, indexes to table values, or for the construction of a result from a number of constituent elements. Many times, decompositions of floating point numbers into their integer and fractional parts occur in the critical computational path. As a result, the speeds at which the mathematical functions may be executed are often times limited.

FIG. 1 illustrates an ANSI/IEEE standard 754-1985, IEEE standard for binary floating-point arithmetic, IEEE, New York 1985 (IEEE), representation for a single precision floating-point representation 101 and a double precision representation 102. The IEEE single precision representation 101 requires a 32-bit word. This 32-bit word may be represented as bits numbered from right to left (bits 0 to 31 as least significant bit (LSB) to most significant bit (MSB)). The most significant bit 103 is a sign bit. The next eight bits 104 (bits 23 to 30) are exponent bits. The final 23 bits 105 (bits 0 through 22) are the fractions representation bits (also known as the significand). For IEEE double precision representation 102, which includes 64 bits, a most significant bit 106 is a sign bit, bits 107 are the exponent bits (11 bits), and the final representative bits 108 are the 52 fraction representation bits (also known as the significand).

As an example of the decomposition of floating-point numbers into their integer and fractional parts, the following equations are presented to illustrate one such example:

Given w=x*A

where A=1/B

find n and r where x=N*B+r

where N is a whole number, and A, B, r, w and x are floating-point quantities. Therefore, the problem may be restated as: given an input argument, x, and constants A and B, how many times N does the value B occur in the value x, and what is the remainder? Moreover, N is often used as an index to perform a table lookup, or as the exponent of a subsequent quantity such as 2^{N}. Therefore, N needs to be represented both as an integer (Nᵢₙₜ), and as a floating-point quantity (N_{flt}). Thus, three quantities are needed from the computation: Nᵢₙₜ (N as an integer), N_{flt} (N as a floating-point value) and r as a floating-point value.

A typical process would convert w to an unnormalized rounded integer. The value computed is then used to compute N_{flt} by having this number normalized as a whole number and to compute Nᵢₙₜ by converting the value to an integer. The r may be computed by subtracting the quantity of N_{flt}*B from x.

Table I illustrates the typical method of computing Nᵢₙₜ, N_{flt}, and r in terms of instruction level pseudo-code. As can be seen from Table I, there are three floating point operations handled by a floating-point arithmetic and logic unit (Falu), and one integer operation handled by an integer arithmetic and logical unit (Ialu). Note that the numbers in parentheses refer to cumulative instruction cycle count (latency) for a processor such as an Intel Itanium™ processor.

TABLE I

| | | |
|---|---|---|
| Falu op 1: | w=x*A | (1) |
| Falu op 2: | w_rshifted=convert_to_unnormalized_{—} | (6) |
| | rounded_int(w) | |
| Falu op 3: | N_{flt}=convert_to_normalized_whole_{—} | (13) |
| | number(w_rshifted) | |
| Ialu op 1: | Nᵢₙₜ=convert_to_integer(w_rshifted) | (14) |
| | Nᵢₙₜ available | (18) |
| Falu op 4: | r=x−N_{flt}*B | (18) |
| | r available | (23) |

As shown above, for a typical microprocessor, such as Itanium™ microprocessor from Intel Corporation, this process may consume up to 23 instruction cycles, which sometimes are not acceptable.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating an IEEE representation of floating point values in single and double precision.

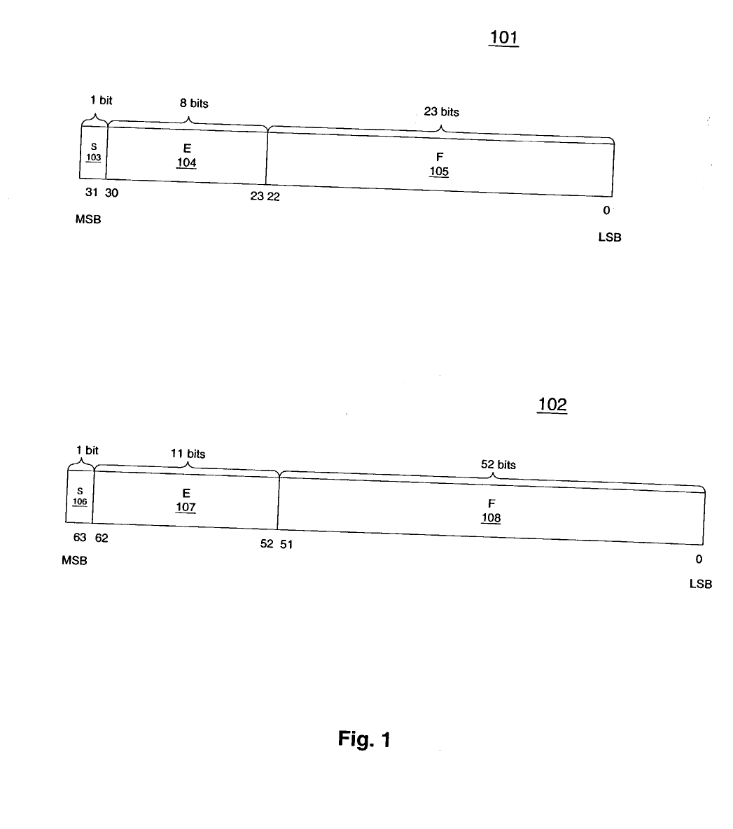

FIG. 2 is a block diagram illustrating an exemplary integer rounding operation.

FIG. 3 is a block diagram illustrating an exemplary integer rounding operation in accordance with one embodiment.

FIG. 4 is a block diagram illustrating an exemplary integer rounding operation in accordance with one embodiment.

FIG. 5 is a flow diagram illustrating an exemplary integer rounding process in accordance with one embodiment.

FIG. 6 is a block diagram illustrating an exemplary integer rounding operation in accordance with one embodiment.

FIG. 7 is a flow diagram illustrating an exemplary integer rounding process in accordance with one embodiment.

FIG. 8 is a block diagram illustrating an exemplary computer which may be used to perform an integer rounding operation.

### DETAILED DESCRIPTION

A rounding mode insensitive efficient method and apparatus for integer rounding are described herein. In the following description, numerous specific details are set forth. However, it is understood that embodiments of the invention may be practiced without these specific details. In other instances, well-known circuits, structures and techniques have not been shown in detail in order not to obscure the understanding of this description.

Some portions of the detailed descriptions which follow are presented in terms of algorithms and symbolic representations of operations on data bits within a computer memory. These algorithmic descriptions and representations are used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar data processing device, that manipulates and transforms data represented as physical (e.g. electronic) quantities within the computer system's registers and memories into other data similarly represented as physical quantities within the computer system memories or registers or other such information storage, transmission or display devices.

Embodiments of the present invention also relate to apparatuses for performing the operations described herein. An apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as Dynamic RAM (DRAM), EPROMs (erasable programmable ROMs), EEPROMs (electrically erasable programmable ROMs), magnetic or optical cards, or any type of media suitable for storing electronic instructions, and each of the above storage components is coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods. The structure for a variety of these systems will appear from the description below. In addition, embodiments of the present invention are not described with reference to any particular programming language. It will be appreciated that a variety of programming languages may be used to implement the teachings of the embodiments of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

There are many approaches to reduce the number of floating point operations necessary to compute Nᵢₙₜ, N_{flt}, and r. In one approach, processing logic computes A*B+S, where S and B are constants and A is a floating-point number. The constant S is chosen such that the addition of S to A*B will shift the rounded integer portion of A*B into the rightmost bits of the significand. N_{flt} is computed by subtracting S from the value of (A*B +S), thus creating an integer value. Nᵢₙₜ+S is computed by extracting the significand bits from the resulting value of (A*B+S). Then processing logic computes r by subtracting the quantity of N_{flt}*C from A and extracts low ordered bits from the extracted significand bits, resulting in Nᵢₙₜ.

Table II illustrates the above reducing floating-point operations in instruction-level pseudo-code. Note that as an example, the numbers in parentheses refer to cumulative instruction cycle count (latency) for a processor such as an Intel Itanium™ processor. In one embodiment of the invention, the constant S is chosen such that the addition of S to A*B will shift the rounded integer portion of A*B into the rightmost bit of the significand. Therefore, S can be converted into the integer Nᵢₙₜ, after one Falu operation instead of two. Moreover, the floating-point representation N_{flt}, can be directly obtained by a second Falu operation that subtracts S from the first Falu result. It can be seen that the desired quantities are obtained with one less Falu instruction. Thus, the embodiment of the invention results in a savings of seven cycles of overall latency on a processor, such as an Intel Itanium™ processor.

TABLE II

| | | |
|---|---|---|
| Falu op 1: | w_plus_S_rshifted= A*B + S | (1) |
| Falu op 2: | N_{flt}=w_plus_S_rshifted−S | (6) |
| Ialu op 1: | ni_plus_S=extract_significand_bits(w_{—} | (9) |
| | plus_S_rshifted) | |
| Falu op 3: | r =A − N_{flt} * C | (11) |
| Ialu op 2: | Nᵢₙₜ=extract_low_order_bits(ni_plus_S) | (11) |
| | Nᵢₙₜ available | (12) |
| | r available | (16) |

A performance benefit also accrues to many software pipeline loops involving this embodiment of the invention. Many loops are resource limited by the number of floating-point instructions required by the computation. Since this process involves one less floating-point instruction than a typical method, maximum throughput for the loop is increased.

It is important to select constant S in order to achieve the goal of reducing floating point operations. For case of discussion, suppose the floating-point representation contains b bits in the significand (e.g., b=64), an explicit integer bit, and b-i bits of fraction. The exponent field of the floating-point representation locates the binary point within or beyond the significant digits. Therefore, the integer part of a normalized floating-point number can be obtained in the right-most bits of the significand by an unnormalizing operation, which shifts the significand b-I bits to the right, rounds the significand, and adds b-I to the exponent. The significand contains the integer as a b-bit, 2's complement integer. The low-order bits of the significand containing the integer part of original floating-point number can be obtained by adding to the number, a constant 1.10 . . . 000*2^{b-1} (e.g., constant S).

The resulting significand contains the integer as a (b-2) bit 2's complement integer. The bit immediately to the left of the b-2 zeros in the fractional part is used to ensure that for negative integers the result does not get renormalized, thereby shifting the integer left from its desired location in the rightmost bit of the significand. If fewer than b-2 bits are used in the subsequent integer operations, then the instructions in Table II are equivalent to those of Table I for computing Nᵢₙₜ, N_{flt}, and r.

The selection of S can be generalized if the desired result is to be m, where m=n*2^{k}. In this case, the exponent of the constant would be (b-k-1). In this embodiment, the selection of S is useful when the desired integer needs to be divided into sets of indices for a multi-table lookup. For example, n may be broken up such that n=n₀*2⁷+n₁*2⁴+n₂ to compute indices n₁ and n₂ for accessing 16-entry and 8-entry tables. With this embodiment, it is required that S be available at the same time as the constant A. In one embodiment of the invention, the constant S can be loaded from memory or on a processor such as Intel's Itanium™, S is easily generated with the following instructions: 1) movl of the 64-bit IEEE double precision bit pattern, followed by 2) setf.d to load S into a floating-point register.

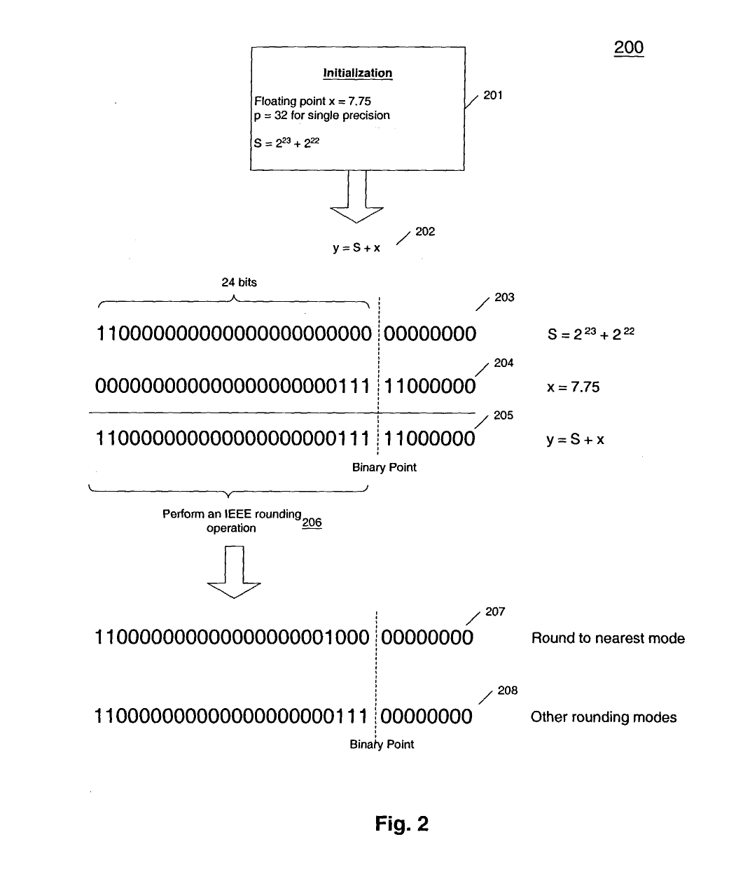

FIG. 2 is block diagram illustrating an embodiment of the above exemplary process. The process involved in FIG. 2 may be performed by processing logic that may comprise hardware (circuitry, dedicated logic, etc.), software (such as is run on a general purpose computer system or a dedicated machine), or a combination of both. In this embodiment, at block 201, as an example, a floating point value of 7.75 is used for single precision operation which includes 32 bits and a constant S has a value of 2²³+2²². Processing logic adds constant S to the floating point value, resulting in y 202. The corresponding binary values are represented by values 203 to 205 respectively. After, y 205 is computed by adding constant S to the floating point value, an IEEE rounding operation is typically performed which cover 24 bits (processing block 206) and results in value 207 or 208 dependent upon the rounding mode selected. Further detailed information concerning the above process can be found in a PCT (Patent Cooperation Treaty) application No. PCT/RU01/00286, filed Jul. 13, 2001, which is assigned to a common assignee of the present application.

However, the above process is subject to the rounding mode of the IEEE rounding operation. For example, for a rounding mode of “round to nearest” mode, the result would be represented by value 207, while other rounding modes would result in a different value (e.g., value 208). That is, if the rounding mode is “round towards zero” mode or “round towards negative infinity” mode, the resulting N will actually be the truncation of x, denoted as └x┘ while in “round towards positive infinity” mode, the resulting N will be the next integer above x, denoted as ┌x┐. In summary,

|x−shifter technique (x)|<=B

where B=½ if the rounding mode is “round to nearest” mode, but B=1 otherwise.

However, in many applications, including those of transcendental function calculations, it is crucial for accuracy and efficiency purposes to have B as close to the theoretical minimum of ½ as possible. For example, a branch-free algorithm for the trigonometric functions currently used in a processor, such as Intel Pentium® 4 processor, generating N=1 when 0<x<<½ would result in severe numerical inaccuracy.

Thus, in an application of the above shifter technique, one would need to ensure the “round to nearest” mode be in effect. For a processor, such as the Intel Itanium™ processor, this is usually not problematic since one can efficiently select “round to nearest” mode dynamically. However, for a processor, such as the Intel Pentium 4™ processor, this kind of dynamic setting of the rounding mode is relatively expensive and may cause serious efficiency loss in may situations.

Accordingly, an advanced technique is introduced, according to one embodiment, in which the process works for any rounding modes. The process performs rounding explicitly, instead of relying on the floating point hardware. In one embodiment, a constant S is added to the input number x, where S is selected as:

S=2^{p-k-1}+2^{p-k-2}+½

where k>0 and |x|<=2^{p-k-2}−1.

For the purposes of easy calculations, constant S₁ and S₂ are used, such that:

S₁=2^{p-k-1}+2^{p-k-2}+½

S₂=2^{p-k-1}+2^{p-k-2}

and the following operations may be involved:

y=S₁+x

y′=truncₖ (y)

N=y′−S₂

Where truncₖ (y) means clearing the lowest k bits of y using, for example, a logical AND with a bit mask operation. For a processor, such as the Intel Pentium 4™ processor, this sequence of operations may be implemented in 12 instruction cycles, assuming that S₁ and S₂ are in xmm1 and xmm2 registers respectively, and the bit mask, such as one shown below,

| L - k bits | k bits |
|---|---|
| 11 .... 11 | 00 .... 00 |

is contained in the lower half of xmm3 register. The L stands for the data width (e.g., L is 32 for single precision and 64 for double precision). A typical operation may be implemented as follows:

ADDSD xmm0, xmm1 ; 4 cycles

ANDPD xmm0, xmm3 ; 4 cycles

SUBSD xmm0, xmm2 ; 4 cycles

As described above, it is often the case that the integer value of N is used as an index into a table, and for which purpose, it often needs to be shifted left, since each table entry usually includes multiple bytes (e.g., 8 bytes if each entry is a double precision value). By selecting an appropriate k, one may be able to eliminate the required shifting operation. For example, in sine and cosine functions for a processor, such as Intel Pentium 4 processor, k =21 is used. The integer value N may be extracted by an instruction of:

pextrw edx, xmm0, 1

The above operation shifts the value left by 5 (e.g., 21-16) bits as required for the table indexing.

One may achieve a “round to integer value” effect by truncating to integer value after an addition of ½. Moreover, to minimize the effect of the native rounding (for a variety of rounding modes), according to one embodiment, the operations may be performed at an insignificant bit level. In one embodiment, a sequence of operations may be implemented as follows:

y=S₁+x+e, e is the rounding error incurred

y=S₂+x′+½, x′is x+e

truncₖ(y)=└y┘

truncₖ(y)=S₂+└x′+½┘, because S₂ is integer valued

truncₖ(y)−S₂=N

Here N is essentially rounded to an integer value of the value x′. The x is perturbed by the rounding error e. Note that the range of rounding error e is tied to the prevalent rounding mode:

| Prevalent Rounding Mode | Range of Rounding Error e |
|---|---|
| nearest | −2^{-(k+1)} <= e <= 2^{-(k+1)} |
| zero, negative infinite | −2^{-k} < e <= 0 |
| positive infinite | 0 <= e < 2^{-k} |

Finally, because

x′−N<=1/2

we know that

−½<=(x−N)+e<=½

or

−½−e<=x−N<=½−e

Note that the size of the “reduced argument” |x−N| may exceed ½ up to 2^{-(k+1)} in “round to nearest” mode and up to ₂-k in “round up” mode. Provided k is sufficiently large, the rounding error is usually insignificant. However, the larger k is selected, the smaller is the acceptable range of |x|<=2^{p-k-2}−1. Therefore, a balance needs to be considered depending on the intended applications.

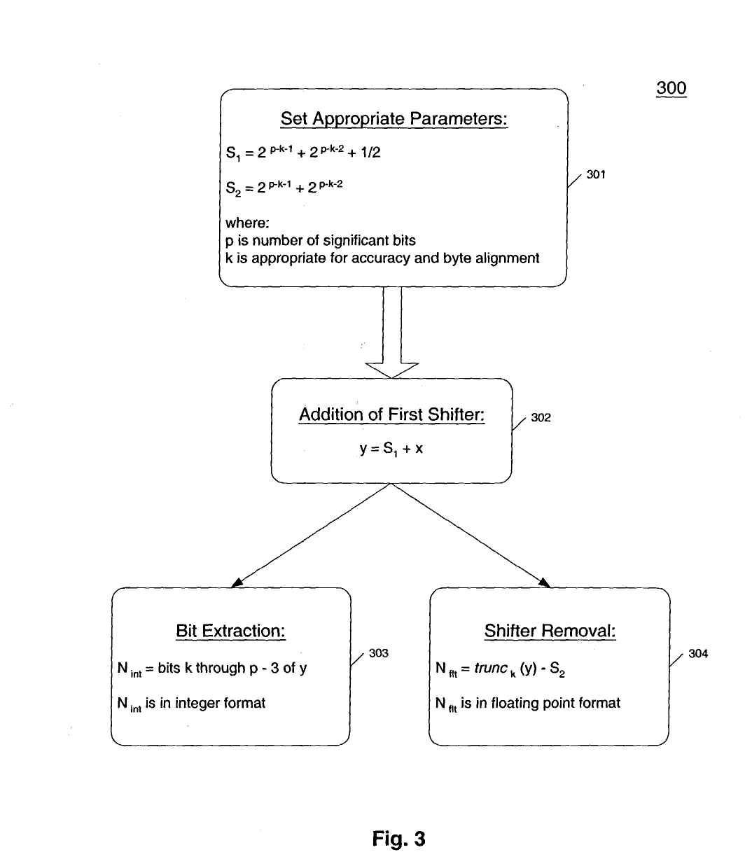

FIG. 3 is a block diagram illustrating an exemplary operation according to one embodiment. The exemplary operation 300 may be performed by processing logic that may comprise hardware (circuitry, dedicated logic, etc.), software (such as is run on a general purpose computer system or a dedicated machine), or a combination of both. In one embodiment, exemplary operation 300 includes an initialization 301 where constants S₁ and S₂ are selected as:

S₁=2^{p-k-1}+2^{p-k-2}+½

S₂=2^{p-k-1}+2^{p-k-2}

Where p is number of significant bits and k is an appropriate value selected for accuracy and byte alignment purposes. In one embodiment, k is selected such that |x|<=2^{2p-k-2}−1 and the prevalent rounding mode is insignificant to the accuracy of the rounded integer.

At block 302, y is calculated by adding constant S₁ to the input x and optionally a rounding operation, such as an IEEE rounding operation, may be performed. At block 303, Nᵢₙₜ, which is in integer format, may be extracted from y. In one embodiment, Nᵢₙₜ is extracted by masking out bits k through (p-3) of y. At block 304, N_{flt}, which is in floating point format, may be extracted from y via a shifter removal operation. In one embodiment, N_{flt} is calculated by truncₖ(y)−S₂. Other operations may be included.

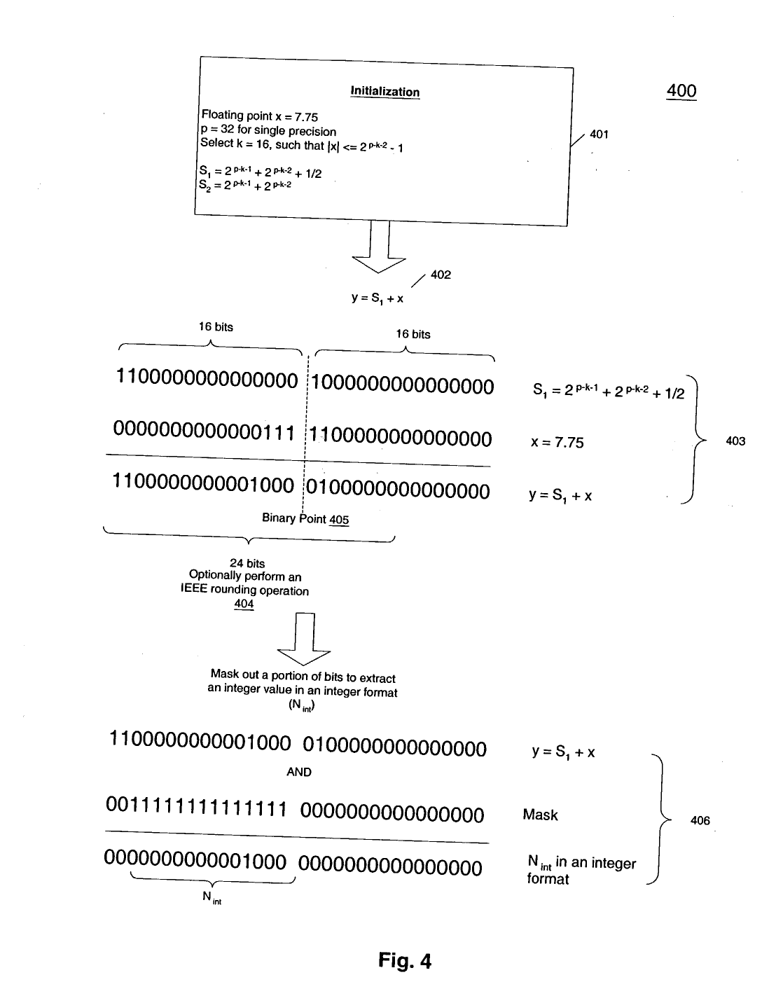

FIG. 4 is a block diagram illustrating an exemplary operation for integer rounding according to one embodiment. The exemplary operation 400 may be performed by processing logic that may comprise hardware (circuitry, dedicated logic, etc.), software (such as is run on a general purpose computer system or a dedicated machine), or a combination of both. Referring to FIG. 4, at block 401, initialization is performed including selecting constants k, S₁, and S₂. In this example, k is selected as 16. At block 402, constant S₁ is added to x having a floating point value of 7.75. The corresponding binary operations are presented at block 403. At block 404, an IEEE rounding operation may be performed. Note that a typical IEEE rounding operation is performed over 24 bits of the input value (e.g., y). K is selected as 16 such that the effective rounding location of the rounding operation (e.g., 24 bits) is far away from binary point 405. As a result, the result of the rounding operations is insignificant regardless of the prevalent rounding mode used. At block 406, an integer value in an integer format Nᵢₙₜ is extracted from the result of block 404 by masking out a portion of bits from the rounded y. Other operations may be included.

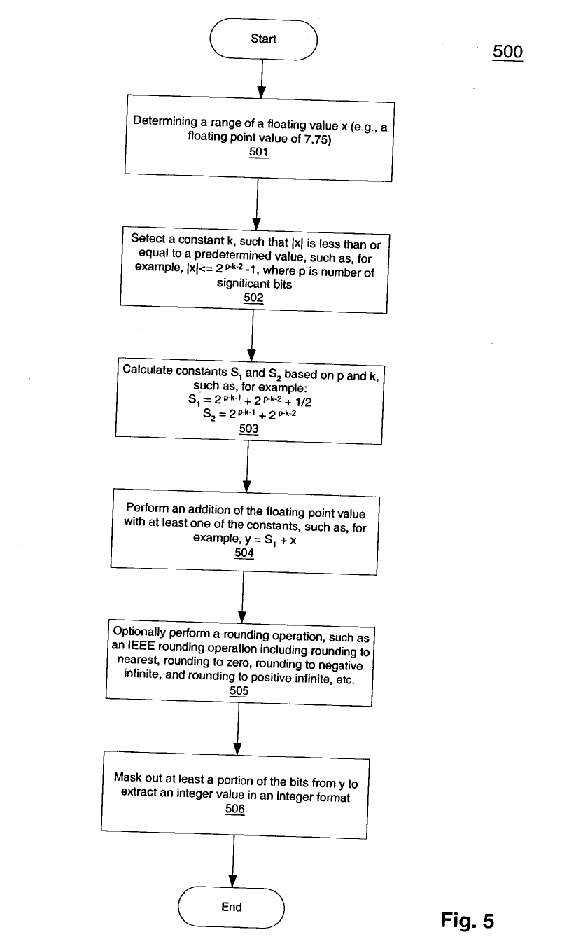

FIG. 5 is a flow diagram illustrating an exemplary process for integer rounding according to one embodiment. The exemplary process 500 may be performed by processing logic that may comprise hardware (circuitry, dedicated logic, etc.), software (such as is run on a general purpose computer system or a dedicated machine), or a combination of both. In one embodiment, exemplary process 500 includes adding a first value with a first constant, resulting in a second value, optionally performing a rounding operation on the second value, resulting in a third value, and extracting at least a portion of bits from the third value to generate an integer component corresponding to the first value, the first constant being selected such that an accuracy of the integer component is independent of a rounding mode of the rounding operation.

Referring to FIG. 5, when an input of a floating point value x (e.g., 7.75) is received, at block 501, x is examined to determine a range of x. At block 502, a constant k is selected, such that lxl is less than or equal to a predetermined value, such as |x|<=2^{p-k-2}−1, where p is number of significant bits based on the precision of the operation (e.g., 32 bits for single precision and 64 bits for double precision). At block 503, a constant, which may include constants S₁ and S₂ is calculated based on p and k. In one embodiment, S₁ and S₂ are determined as follows:

S₁=2^{p-k-1}+2^{p-k-2}+½

S₂=2^{p-k-1}+2^{p-k-2}

At block 504, the floating point value x is added with S₁ resulting in y (e.g., y=S₁+x). At block 505, an IEEE rounding operation is optionally performed on y, including a variety of rounding modes, such as, for example, “round to nearest”, “round to zero”, “round to negative infinite”, and “round to positive infinite” modes. At block 506, at least a portion of bits is masked out and extracted from the rounded y, resulting in an integer format Nᵢₙₜ.

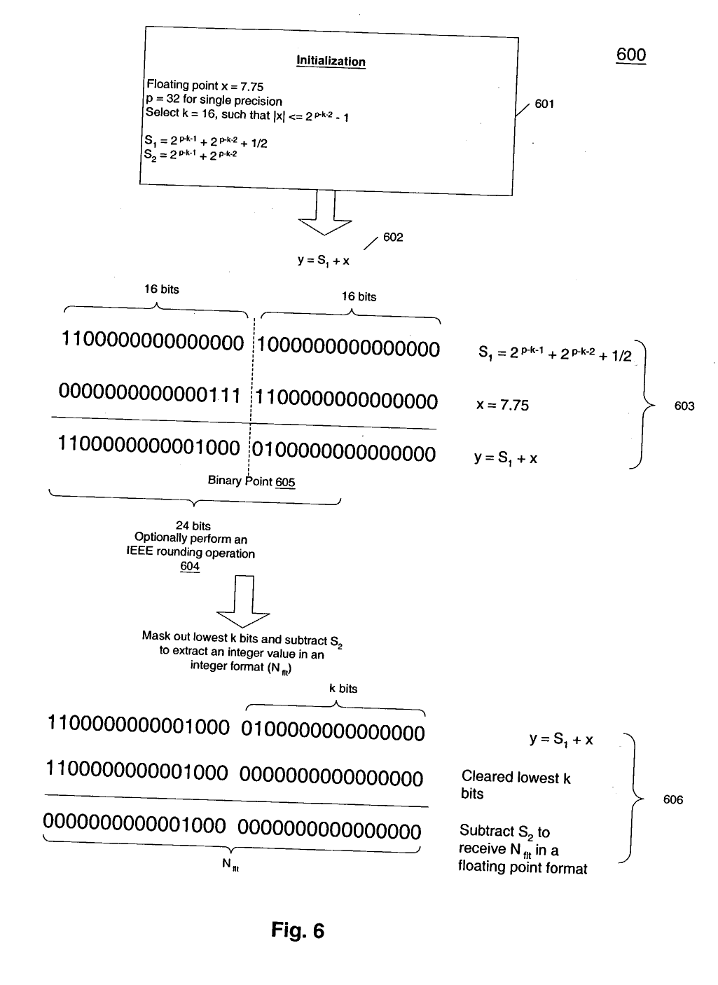

FIG. 6 is a block diagram illustrating an exemplary operation for integer rounding according to one embodiment. The exemplary operation 600 may be performed by processing logic that may comprise hardware (circuitry, dedicated logic, etc.), software (such as is run on a general purpose computer system or a dedicated machine), or a combination of both. Referring to FIG. 6, at block 601, initialization is performed including selecting constants k, S₁, and S₂. In this example, k is selected as 16. At block 602, constant S₁ is added to x, where x has a floating point value of 7.75. The corresponding binary operations are presented in block 603. At block 604, an IEEE rounding operation may be performed. Note that a typical IEEE rounding operation is performed over 24 bits of the input value (e.g., y). K is selected as 16 such that the effective rounding location of the rounding operation (e.g., 24 bits) is far away from binary point 605. As a result, the result of the rounding operations is insignificant regardless of the prevalent rounding mode used. At block 606, an integer value in a floating point format N_{flt} is extracted from the result of block 604 by masking out lowest k bits and subtracting S₂ from the rounded y. Other operations may be included.

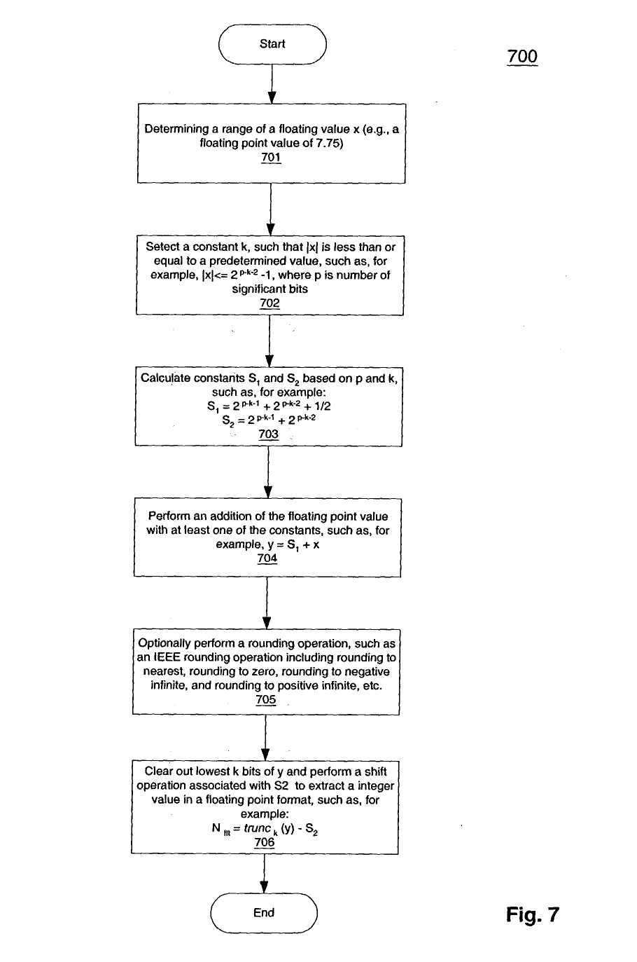

FIG. 7 is a flow diagram illustrating an exemplary process for integer rounding according to one embodiment. The exemplary process 700 may be performed by processing logic that may comprise hardware (circuitry, dedicated logic, etc.), software (such as is run on a general purpose computer system or a dedicated machine), or a combination of both. Referring to FIG. 7, when an input of a floating point value x (e.g., 7.75) is received, at block 701, x is examined to determine a range of x. At block 702, a constant k is selected, such that |x| is less than or equal to a predetermined value, such as |x|<=2^{p-k-2}−1, where p is number of significant bits based on the precision of the operation (e.g., 32 bits for single precision and 64 bits for double precision). At block 703, a constant, which may include constants S₁ and S₂ is calculated based on p and k. In one embodiment, S₁ and S₂ are determined as follows:

S₁=2^{p-k-1}+2^{p-k-2}+½

S₂=2^{p-k-1}+2^{p-k-2}

At block 704, the floating point value x is added with Si resulting in y (e.g., y=S₁+x). At block 705, an IEEE rounding operation is optionally performed on y, including a variety of rounding modes, such as, for example, “round to nearest”, “round to zero”, “round to negative infinite”, and “round to positive infinite” modes. At block 706, lowest k bits of rounded y are cleared and a shift operation is performed, resulting in an integer in a floating point format N_{flt}. In one embodiment, N_{flt} may be obtained by:

N_{flt}=truncₖ(y)=S₂

As described above, some computations need to retrieve values from one or more lookup tables. Often, the addresses of the lookup tables require certain shifting operations. According to one embodiment, constant k may be selected such that such shifting operations may be reduced or eliminated. Embodiments of the invention may incorporate the byte offset of a lookup table address into an integer representation of the rounded integer value.

For example, consider a case where the value |x|<2¹⁶ has to be rounded to an integer value represented by an integer variable N. In addition, two double precision (e.g., 8 bytes for each member) values have to be loaded from one or more tables, such as:

Val_{—}1=dbl_table (2N)

Val_{—}2=dbl_table (2N+1)

In a programming language implementation, such as assembly programming language, the integer representation N is left shifted by 4 bits before adding to the beginning address of the table, such as dbl_table. According to one embodiment, such 4 bits shifting may be incorporated into an embodiment of the invention without extra instructions. For example, constant k can be selected as k=20 for the shifters:

Y=(S₁+x)−S₂

While bits 20 onwards of y contain N, the second long word (e.g., bit 16) onwards of y contains in N left shifted by 4 bits. It is quite convenient to extract the second long word of a floating point register on a processor, such as the Intel Pentium 4™ processor. Since k=20, the error (e.g., bias e) caused by a rounding operation may be ignored.

It will be appreciated that the embodiments of the invention may be applied in other cases where the bias e caused by a rounding operation may be reduced or eliminated. Note that the bias e is introduced by a native rounding operation in operation S₁+x. If this rounding operation is rounded towards zero, there will be no bias introduced. Hence, if the lower bits of x can be masked off beforehand, such that (1) no rounding off will take place in the operation S₁+masked_off(x), and (2) the masking off operation does not affect the numeric values of the result, namely bits in x corresponding to ¼ and higher (e.g., ¼½, 1, 2, etc.) are not affected, the bias may be removed.

For example, consider a computation of double precision exponential function exp(A). Typically, the value of x is restricted to:

x=A(32/log(2)) where |x|<2¹⁶

With k selected as 20, the bias is removed by masking off the lower 34 bits of x before the shifting operation is applied.

In addition, in a more general setting, x may be restricted to:

|x|<2^{M}<=2^{p-k-2}

provided constant k can be selected to satisfy the constraint of:

(p−k)+1<=p−M−1

then the bias may be almost completely removed by masking off L least significant bits (LSB) of x for any L satisfying p−k+1, p−M−1].

The analysis can be stated in a way similar to the one described above. We denote the masked_off portion of x by xₗ, thus

Masked₁₃ off(x)=xₗ;x=xₗ+xₜ

y=S₁+xₗ

y=S₂+xₗ+½

truncₖ(y)=S₂+└xₗ+½┘

truncₖ(y)=S₂+└xₗ+xₜ+½┘

truncₖ(y)=S₂+└x+½┘

Thus, |N−x|<=½ without bias.

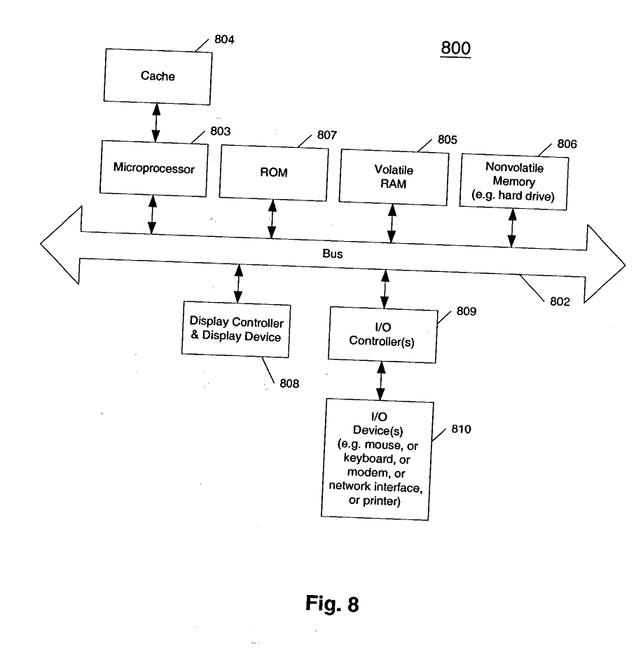

FIG. 8 is a block diagram of an exemplary computer which may be used with an embodiment. For example, system 800 shown in FIG. 8 may perform the processes shown in FIGS. 2 to 7. In one embodiment, exemplary system 800 includes a processor having one or more arithmetic logical units (ALUs), a process executed by the processor from a memory to cause the processor to add a first value with a first constant, resulting in a second value, optionally perform a rounding operation on the second value, resulting in a third value, and extract at least a portion of bits from the third value to generate an integer component corresponding to the first value, the first constant being selected such that an accuracy of the integer component is independent of a rounding mode of the rounding operation, the integer component being suitable to be operated by the one or more ALUs.

Note that while FIG. 8 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention.

As shown in FIG. 8, the computer system 800, which is a form of a data processing system, includes a bus 802 which is coupled to a microprocessor 803 and a ROM (read-only memory) 807, a volatile RAM (random access memory) 805, and a non-volatile memory 806. The microprocessor 803, which may be a Pentium™ processor from Intel Corporation, is coupled to cache memory 804 as shown in the example of FIG. 8. The bus 802 interconnects these various components together and also interconnects these components 803, 807, 805, and 806 to a display controller and display device 808, as well as to input/output (I/O) devices 810, which may be mice, keyboards, modems, network interfaces, printers, and other devices which are well-known in the art. Typically, the input/output devices 810 are coupled to the system through input/output controllers 809. The volatile RAM 805 is typically implemented as dynamic RAM (DRAM) which requires power continuously in order to refresh or maintain the data in the memory. The non-volatile memory 806 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 8 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 802 may include one or more buses connected to each other through various bridges, controllers, and/or adapters, as is well-known in the art. In one embodiment, the I/O controller 809 includes a USB (Universal Serial Bus) adapter for controlling USB peripherals.

Thus, a rounding mode insensitive efficient method and apparatus for integer rounding have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method, comprising:
adding a first value with a first constant, resulting in a second value;
optionally performing a rounding operation on the second value, resulting in a third value; and
extracting at least a portion of bits from the third value to generate an integer component corresponding to the first value, the first constant being selected such that an accuracy of the integer component is independent of a rounding mode of the rounding operation.

2. The method of claim 1, further comprising:
examining the first value to determine a range of the first value; and
selecting the first constant based on the determined range of the first value.

3. The method of claim 2, wherein the first constant is selected such that the first value is less than or equal to a threshold based on the first constant.

4. The method of claim 1, wherein extracting at least a portion of bits from the third value comprises:
masking out a portion of bits of the third value, resulting in a fourth value; and
shifting the fourth value to extract the integer component.

5. The method of claim 1, wherein extracting at least a portion of bits from the third value comprises subtracting a second constant from the third value to generate the integer component.

6. The method of claim 5, wherein the first constant comprises a value of (2^{p-k-1}+2^{p-k-2}+½), the second constant comprises a value of (2^{p-k-1}+2^{p-k-2}), and wherein p represents a number of significant bits of the first value and k is less than p.

7. The method of claim 6, further comprising clearing lowest k bits of the third value prior to the subtraction.

8. The method of claim 6, wherein the subtraction is performed via a shift operation.

9. The method of claim 1, wherein a number of bits corresponding to the first constant is less than a number of bits operated on by the rounding operation.

10. The method of claim 1, wherein the first constant comprises a value of (2^{p-k-1}+2^{p-k-2}+½), wherein p represents a number of significant bits of the first value and k is less than p.

11. The method of claim 1, wherein the addition of the first value with the first constant is performed via a shift operation of the first value.

12. The method of claim 1, wherein the first value is a floating point value.

13. A machine-readable medium having executable code to cause a machine to perform a method, the method comprising:
adding a first value with a first constant, resulting in a second value;
optionally performing a rounding operation on the second value, resulting in a third value; and
extracting at least a portion of bits from the third value to generate an integer component corresponding to the first value, the first constant being selected such that an accuracy of the integer component is independent of a rounding mode of the rounding operation.

14. The machine-readable medium of claim 13, wherein the method further comprises:
examining the first value to determine a range of the first value; and
selecting the first constant based on the determined range of the first value.

15. The machine-readable medium of claim 14, wherein the first constant is selected such that the first value is less than or equal to a threshold based on the first constant.

16. The machine-readable medium of claim 13, wherein extracting at least a portion of bits from the third value comprises:
masking out a portion of bits of the third value, resulting in a fourth value; and
shifting the fourth value to extract the integer component.

17. The machine-readable medium of claim 13, wherein extracting at least a portion of bits from the third value comprises subtracting a second constant from the third value to generate the integer component.

18. The machine-readable medium of claim 17, wherein the first constant comprises a value of (2^{p-k-1}+2^{p-k-2}+½), the second constant comprises a value of (2^{p-k-1}+2^{p-k-2}), and wherein p represents a number of significant bits of the first value and k is less than p.

19. The machine-readable medium of claim 18, wherein the method further comprises clearing lowest k bits of the third value prior to the subtraction.

20. The machine-readable medium of claim 18, wherein the subtraction is performed via a shift operation.

21. The machine-readable medium of claim 13, wherein number of bits corresponding to the first constant is less than a number of bits operated on by the rounding operation.

22. The machine-readable medium of claim 13, wherein the first constant comprises a value of (2^{p-k-1}+2^{p-k-2}+½), wherein p represents a number of significant bits of the first value and k is less than p.

23. The machine-readable medium of claim 13, wherein the addition of the first value with the first constant is performed via a shift operation of the first value.

24. The machine-readable medium of claim 13, wherein the first value is a floating point value.

25. A data processing system, comprising:
a processor having one or more arithmetic logical units (ALUs);
a process executed by the processor from a memory to cause the processor to
add a first value with a first constant, resulting in a second value,
optionally perform a rounding operation on the second value, resulting in a third value, and
extract at least a portion of bits from the third value to generate an integer component corresponding to the first value, the first constant being selected such that an accuracy of the integer component is independent of a rounding mode of the rounding operation,
the integer component being suitable to be operated by the one or more ALUs.

26. The data processing system of claim 25, wherein the process further causes the processor to:
examine the first value to determine a range of the first value; and
select the first constant based on the determined range of the first value.

27. The data processing system of claim 25, wherein the process further causes the processor to:
mask out a portion of bits of the third value, resulting in a fourth value; and
shift the fourth value to extract the integer component.

28. The data processing system of claim 25, wherein the process further causes the processor to:
clear a portion of least significant bits of the third value prior to the subtraction subtracting a second; and
subtract a second constant from the third value to generate the integer component.

29. The data processing system of claim 25, wherein the first constant comprises a value of (2^{p-k-1}+w^{p-k-2}+½), wherein p represents a number of significant bits of the first value and k is less than p.

30. The data processing system of claim 28, wherein the first constant comprises a value of (2^{p-k-1}+2^{p-k-2}+½), the second constant comprises a value of (2^{p-k-1}+2^{p-k-2}), and wherein p represents a number of significant bits of the first value and k is less than p.
